(19) United States
(12) Patent Application Publication
(10) Pub. No.: US 2026/0332040 A1
(43) Pub. Date: Oct. 22, 2026

(54) POWER CONVERTER, IN PARTICULAR FOR AN AIRCRAFT, AND ASSOCIATED METHODS

(71) Applicant: SAFRAN AEROSYSTEMS, Plaisir (FR)

(72) Inventor: Menouar Ameziani, Moissy-Cramayel (FR)

(73) Assignee: SAFRAN AEROSYSTEMS, Plaisir (FR)

(21) Appl. No.: 19/099,471

(22) PCT Filed: Aug. 1, 2023
(86) PCT No.: PCT/FR2023/051229

§ 371 Date: Jan. 28, 2025

(30) Foreign Application Priority Data
Aug. 5, 2022 (FR) FR2208139

(51) Int. Cl. H02M 1/32; B64D 41/00; H02M 7/483; H02M 7/5387

(52) U.S. Cl. CPC H02M 1/325; B64D 41/00; H02M 7/483; H02M 7/53871

(57) ABSTRACT

Disclosed is an electrical power converter for supplying power to an electric load, in particular of an aircraft, comprising
a supply module;
at least one main switching arm comprising a first main switch and a second main switch;
at least one intermediate connection arranged between the first main switch and the second main switch and intended to be connected to one phase of the electric load;
an auxiliary circuit comprising at least one control line comprising at least one switching cell.

The switching cell comprises at least one auxiliary switch, particularly an auxiliary switch made of silicon carbide or of gallium nitride.

### TECHNICAL FIELD OF THE INVENTION

The invention relates to electrical power converters, in particular for an aircraft, and more particularly the electrical power converters implementing power components made of silicon carbide (SiC) or of gallium nitride (GaN).

The invention also relates to an aircraft including such a power converter, and a method for supplying power to an electric load, in particular of an aircraft, via such a power converter.

### PRIOR ART

In general, an aircraft comprises an electrical power converter controlling an electric load, for example a three-phase fuel pump of the aircraft, on the basis of a continuous voltage delivered by a bus of the aircraft.

The power converter delivers to the electric load a variable three-phase voltage system so as to regulate the power provided to the electric load. Thus, if the electric load is a pump, the power converter delivers to the pump a variable three-phase voltage system so as to regulate the power provided to the pump and so as to regulate the speed of rotation of the latter.

In order to obtain the three-phase voltage system from the continuous voltage delivered by the bus, the power converter implements switching power components made of silicon to generate two voltage levels (also called three-phase power converter with two voltage levels).

The switching power components made of silicon generally comprise transistors of the metal oxide semiconductor field effect type, also known by the acronym MOSFET, or transistors of the insulated gate bipolar type, also known by the acronym IGBT.

These proven transistor technologies are widely used in aircraft.

However, the switching power components made of silicon generate significant thermal losses leading to an increase in their electricity consumption and a rise in the temperature of these components and of neighbouring components that can lead to a decrease in the service life of these components and of the neighbouring components.

Moreover, the power switching components made of silicon have a significant bulk increasing the bulk of the power converter.

Switching power components of the wide band gap type, also known by the acronym WBG, made of silicon carbide (SiC) and of gallium nitride (GaN), allow to overcome the limitations of the power switching components made of silicon presented above.

However, these components of the WBG type have not yet been proven for aeronautical uses.

### DISCLOSURE OF THE INVENTION

The goal of the invention is to overcome all or a part of these disadvantages, in particular by integrating switching power components of the WBG type into a power converter while guaranteeing a continuity of operation of the power converter upon the failure of one of the components of the WBG type.

Given the above, the object of the invention is an electrical power converter for supplying power to an electric load, in particular of an aircraft, including
a supply module, intended to be connected to a source of power, in particular a source of continuous power;
at least one main switching arm including a first main switch and a second main switch, in particular an identical first main switch and second main switch, respectively comprising a first end and a second end, the first end of the first main switch and the second end of the second main switch being connected to the supply module and the second end of the first main switch being connected to the first end of the second main switch;
at least one intermediate connection, arranged between the first main switch and the second main switch and intended to be connected to a phase of the electric load;
an auxiliary circuit comprising as many control lines as main switching arms, at least one control line including at least one switching cell including
   a first end connected to the supply module and
   a second end connected to the intermediate connection.

The switching cell includes at least one auxiliary switch, in particular an auxiliary switch made of silicon carbide or made of gallium nitride.

The implementation of a wide band gap auxiliary switch WBG made of silicon carbide (SiC) or made of gallium nitride (GaN) allows to reduce the bulk of the power converter and to reduce the thermal losses generated by the electrical power converter.

Preferably, the electrical power converter includes a monitoring module configured to detect a failure or a drift of the auxiliary switch on the basis of functional parameters of the auxiliary switch and to deactivate the auxiliary switch upon the detection of a failure or of a drift of the auxiliary switch.

Advantageously, the supply module includes a supply line comprising a first end and a second end intended to be connected to the source of power and wherein the supply line includes two impedances, in particular two identical impedances, in particular capable of being connected in series.

Preferably, the supply module includes an additional connection arranged between the two impedances and intended to be connected to the first end of the switching cell.

Advantageously, the electrical power converter includes at least one auxiliary switching arm including a first secondary switch and a second secondary switch, in particular an identical first secondary switch and second secondary switch, respectively comprising a first end and a second end, the second end of the first secondary switch being connected to the first end of the second secondary switch.

Preferably, a median connection is disposed between the first secondary switch and the second secondary switch and is connected to the first end of the switching cell of the control line.

Advantageously, the first end of the first main switch and/or of the first secondary switch and the second end of the second main switch and/or of the second secondary switch are connected respectively to a different end of the supply line.

Preferably, the supply module further includes a selection switch including a control input, a first power input, a second power input and a power output,
and configured to connect the power output to one of the power inputs according to a signal received on the control input.

Advantageously,
the first power input is connected to the median connection,
the second power input is connected to the additional connection and
the power output is connected to the first end of the switching cell of the control line.

Preferably, the first main switch, respectively the second main switch, is made of silicon carbide or of gallium nitride.

Advantageously, the first secondary switch, respectively the second secondary switch, is made of silicon.

Preferably, the first main switch, respectively the second main switch, includes a transistor, in particular a dual gate transistor, in particular a dual gate transistor made of gallium nitride.

Advantageously, the auxiliary switch includes at least a first transistor and a second transistor, in particular a first transistor and a second transistor made of gallium nitride, connected in series so that
a source of the first transistor is connected to a drain of the second transistor,
a drain of the first transistor and a source of the second transistor are connected to a different end of the switching cell.

Such a placement in series has a shared source. Alternatively, a shared drain configuration could also be possible.

An aircraft including an electrical power converter as defined above is also proposed.

A method is also proposed for supplying electric power to an electric load, in particular of an aircraft, connected to an electrical power converter as defined above:
comprising the control of the first main switch and of the second main switch so as to supply power a phase of the electric load.

The method for supplying electric power to an electric load further comprises at least
a step of detecting a failure or a drift of the auxiliary switch on the basis of functional parameters of the auxiliary switch, and
a step of deactivating the auxiliary switch upon the detection of a failure or of a drift of the auxiliary switch.

Advantageously, the method for supplying electric power to an electric load further comprises:
a step of controlling the switching cell so as to supply power to the phase by three voltage levels as long as no failure or a drift of the auxiliary switch has been detected, and
a step of deactivating the auxiliary switch, the control of the first main switch and of the second main switch so as to supply power to the phase by two voltage levels.

Preferably, the method for supplying electric power to an electric load further comprises:
upon the detection of the failure or of the drift of the first main switch and of the second main switch, the deactivation of the faulty or drifting switch, and
as long as no failure or a drift of the auxiliary switch has been detected, the control of the switching cell and of the first secondary switch and/or of the second secondary switch so as to supply power to the phase of the load by two voltage levels, the controlled secondary switch being substituted for the faulty switch.

Of course the various features, alternatives and/or embodiments of the present invention can be associated with each other according to various combinations insofar as they are not incompatible or exclusive of each other.

### BRIEF DESCRIPTION OF THE DRAWINGS

The present invention will be better understood and other goals, features and advantages of the invention will also appear upon reading the following detailed description comprising embodiments given only for illustrative purposes in reference to the appended drawings, presented as non-limiting examples, which can be used to complete the comprehension of the present invention and the disclosure of its embodiment and, if necessary, contribute to its definition, and made in reference to the appended drawings in which:

FIG. 1 schematically illustrates an example of an aircraft according to the invention;

FIG. 2 illustrates a circuit diagram of a first embodiment of a power converter according to the invention;

FIG. 3 schematically illustrates an example of an auxiliary switch according to the invention;

FIG. 4 schematically illustrates another example of an auxiliary switch according to the invention;

FIG. 5 schematically illustrates a second example of a supply module according to the invention;

FIG. 6 illustrates a circuit diagram of a second embodiment of a power converter according to the invention;

FIG. 7 illustrates a circuit diagram of a third embodiment of a power converter according to the invention, and

FIG. 8 schematically illustrates an embodiment of a main switching arm.

It should be noted that, in the figures, the structural and/or functional elements common to the different embodiments may have the same references. Thus, unless stated otherwise, such elements have identical structural, dimensional and material properties.

### DETAILED DISCLOSURE OF AT LEAST ONE EMBODIMENT

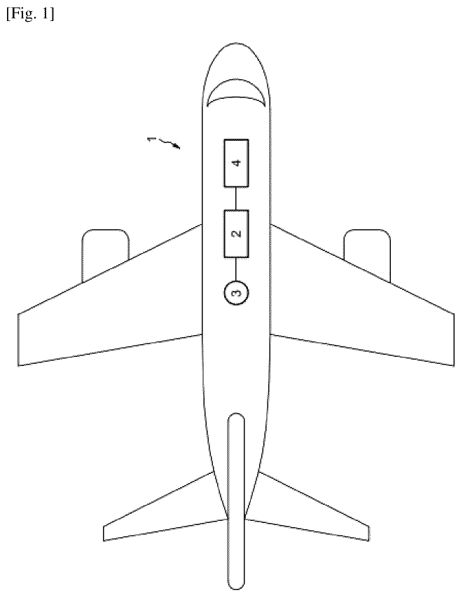

Reference is made to FIG. 1 which schematically illustrates an example of an aircraft 1 including an electrical power converter 2, an electric load 3, to which power is supplied by the electrical power converter 2, and a supply source 4, in particular a continuous supply source 4, including, for example, a bus for supplying continuous-voltage electrical power to the aircraft 1. According to a specific example, the electric load 3 can, for example, be a fuel pump.

Advantageously, the electric load 3 is of the three-phase type so that the electrical power converter 2 delivers a three-phase voltage system to control the electric load 3 on the basis of the continuous voltage delivered by the supply source 4.

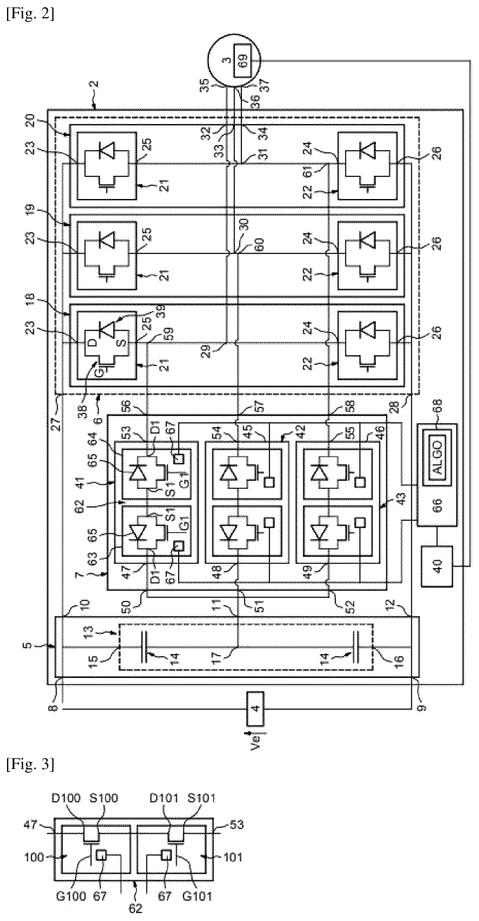

FIG. 2 illustrates a circuit diagram of a first exemplary embodiment of the electrical power converter 2 according to the invention. In the first exemplary embodiment, the electrical power converter 2 connected to the electric load 3 and to the supply source 4 delivering a voltage Ve, in particular continuous voltage Ve, for example 540V.

The electrical power converter 2 can include in particular a supply module 5.

According to an exemplary embodiment, the supply module 5 comprises two input terminals 8, 9, respectively a first input terminal 8 and a second input terminal 9, connected to the supply source 4 so that the voltage Ve is applied between the input terminals 8 and 9. The supply module 5 also comprises three output terminals 10, 11, 12, respectively a first output terminal 10, a second output terminal 11 and a third output terminal 12.

The supply module 5 comprises a supply line 13. The supply line 13 includes two impedances 14. Advantageously, the two identical impedances 14, in particular connected in series, extend between two ends 15, 16, respectively a first end 15 and a second end 16, of the supply line 13.

According to the example presented in FIG. 2, the impedance 14 includes, for example, a capacitor.

The first end 15 of the supply line 13 is connected to the first input terminal 8 and to the first output terminal 10. Moreover, the second end 16 of the supply line 13 is connected to the second input terminal 9 and to the third output terminal 12.

The supply module 5 further includes an additional connection 17, in particular disposed between the two impedances 14, connected to the second output terminal 11.

The electrical power converter 2 can also include a switching module 6. The switching module 6 comprises as many main switching arms as phases of the electric load 3. According to the example presented in FIG. 2, the switching module 6 comprises three main switching arms 18, 19, 20, respectively a first main switching arm 18, a second main switching arm 19 and a third main switching arm 20.

The first main switching arm 18, respectively the second main switching arm 19 and/or the third main switching arm 20, includes at least one first main switch 21, comprising a first end 23 and a second end 25, and at least one second main switch 22, comprising a first end 24 and a second end 26.

Advantageously the first main switch 21 and the second main switch 22 are identical.

As presented in the exemplary embodiment of FIG. 2, the second end 25 of the first main switch 21 is connected to the first end 24 of the second main switch 22.

The first end 23 of the first main switch 21 is connected to a first input 27 of the switching module 6. Moreover, the second end 26 of the second main switch 22 is connected to a second input 28 of the switching module 6. More particularly, the first input 27 of the switching module 6 is connected to the first output terminal 10 of the supply module 5. Moreover, the second input 28 of the switching module 6 is connected to the third output terminal 12 of the supply module 5.

An intermediate connection 29, in particular a first intermediate connection 29, respectively a second intermediate connection 30 and a third intermediate connection 31, preferably arranged between the first main switch 21 and the second main switch 22, of the first main switching arm 18, respectively of the second main switching arm 19 and of the third main switching arm 20, is connected to a first output 32, respectively a second output 33 and a third output 34, of the switching module 6.

The first output 32, respectively the second output 33 and the third output 34, of the switching module 6 is connected to a phase 35, in particular a first phase 35, respectively a second phase 36 and a third phase 37, of the electric load 3.

In a preferred embodiment, the first main switch 21 and the second main switch 22 are identical. Thus arranged, only one exemplary embodiment of the first main switch 21 of the first main switching arm 18 is described in detail.

The first main switch 21 comprises a transistor 38, in particular of the silicon (Si) type, for example of the MOSFET or IGBT type. The transistor 38 can include a diode 39, in particular an internal diode 39.

A drain D of the transistor 38 and a cathode of the diode 39 are connected to the first end 23 of the first main switch 21. Moreover, a source S of the transistor 38 and an anode of the diode 39 are connected to the second end 25 of the first main switch 21. Finally, a gate G of the transistor 38 is connected to a control module 40 of the electrical power converter 2.

Alternatively, the transistor 38 can be a transistor made of silicon carbide including an internal diode, the transistor being connected as described above.

According to yet another alternative, the transistor 38 can be a bipolar transistor to which a diode 39 is added, the diode 39 thus being external. A collector of the transistor 38 is thus connected to the first end 23 of the first main switch 21. Moreover, an emitter of the transistor 38 is thus connected to the second end 25 of the first main switch 21. Finally, a base of the transistor 38 is thus connected to the control module 40 of the electrical power converter 2.

According to an exemplary embodiment, the control module 40 is made from a processing unit.

The electrical power converter 2 can also include an auxiliary circuit 7. The auxiliary circuit 7 comprises as many control lines as main switching arms 18, 19, 20.

According to the exemplary embodiment presented in FIG. 2, the auxiliary circuit 7 comprises three control lines. Thus, more specifically, the auxiliary circuit 7 comprises a first control line 41, a second control line 42 and a third control line 43.

The first control line 41, respectively the second control line 42 and the third control line 43, comprises a first switching cell 44, respectively a second switching cell 45 and a third switching cell 46. Advantageously, the first switching cell 44, the second switching cell 45 and the third switching cell 46 are identical.

The first switching cell 44, respectively the second switching cell 45 and the third switching cell 46, includes a first end 47, respectively a first end 48 and a first end 49, connected to a first input 50, respectively a second unput 51 and a third input 52, of the auxiliary circuit 7 and a second end 53, respectively a second end 54 and a second end 55, connected to an output 56, respectively an output 57 and an output 58, of the auxiliary circuit 7.

The first input 50, respectively the second input 51 and the third input 52, of the auxiliary circuit 7 is connected to the second output terminal 11 of the supply module 5.

The output 56, respectively the output 57 and the output 58, of the auxiliary circuit 7 is connected to a second connection 59, respectively second connection 60 and a second connection 61, located between the first main switch 21 and the second main switch 22 of the first main switching arm 18, representative of the second main switching arm 19 and of the third main switching arm 20.

Since the first switching cell 44, the second switching cell 45 and the third switching cell 46 are identical, only an exemplary embodiment of the first switching cell 44 and of the first control line 41 are now described in detail.

The first switching cell 44 of the first control line 41 comprises an auxiliary switch 62, in particular an auxiliary switch 62 made of silicon carbide (SiC), including a first transistor 63 and a second transistor 64, in particular a first field effect transistor 63 and a second field effect transistor 64 made of silicon carbide (SiC), in particular an identical first transistor 63 and second transistor 64.

A drain D1 of the first transistor 63 is connected to the first end 47 of the first switching cell 44 of the control line 41 and to the cathode of a diode 65, in particular as an internal diode of the first transistor 63.

Moreover, a source S1 of the first transistor 63 is connected to an anode of the diode 65 of the first transistor 63. Finally, the anode of the diode 65 of the first transistor 63 is connected to a source S1 of the second transistor 64.

A drain D1 of the second transistor 64 is connected to the second end 53 of the first switching cell 44 of the control line 41 and to the cathode of the diode 65, in particular as an internal diode of the second transistor 64.

A gate G1 of the first transistor 63, respectively of the second transistor 64, is connected to the control module 40.

Alternatively, the first switching cell 44 is capable of comprising several auxiliary switches 62 connected in series so as to reduce the voltage between the drain D1 and the source S1 of the first transistor 63, respectively of the second transistor 64, to increase the strength of the first transistor 63, respectively of the second transistor 64, at high voltages.

According to an alternative schematically shown in FIG. 3, the auxiliary switch 62 includes a first field effect transistor 100 and a second field effect transistor 101 made of gallium nitride (GaN), advantageously identical.

The first field effect transistor 100 and the second field effect transistor 101 made of gallium nitride do not include an internal diode.

A drain D100 of a first transistor 100 is connected to the first end 47 of the first switching cell 44 of the control line 41. Moreover, a source S100 of the first transistor 100 is connected to a drain D101 of the second transistor 101. Finally, a source S101 of the second transistor 101 is connected to the second end 53 of the first switching cell 44 of the control line 41.

A gate G100 of the first transistor 100, respectively a gate G101 of the second transistor 101, is connected to the control module 40.

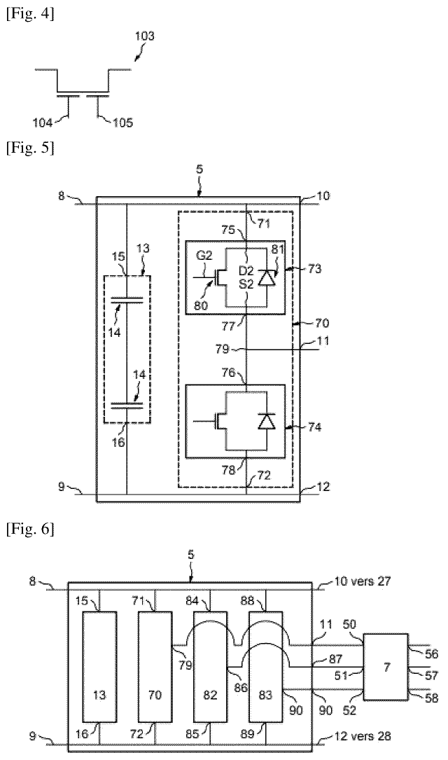

According to yet another embodiment schematically shown in FIG. 4, the auxiliary switch 62 can comprise a dual gate transistor 103, in particular a dual gate transistor 103 made of gallium nitride, controlled by a first gate 104 and a second gate 105.

The electrical power converter 2 further comprises a monitoring module 66, as schematically shown in FIG. 2. The monitoring module 66 is capable of being connected to a sensor 67 implemented in the immediate vicinity of the first transistor 63, respectively of the second transistor 64. The sensor 67 allows to measure a functional parameter of the first transistor 63, respectively of the second transistor 64, and transmit it to the control module 40.

The monitoring module 66, for example made from a processing unit, comprises determination means 68. The determination means 68 allow to determine a failure or a drift of the first transistor 63, respectively of the second transistor 64, of the auxiliary switch 62 on the basis of the functional parameter measured by the sensor 67.

Advantageously, the determination means 68 are, for example, made from a calculation unit implementing a detection algorithm ALGO.

Upon the detection of a failure or of a drift of the first transistor 63, respectively of the second transistor 64, of the auxiliary switch 62, the monitoring module 66 delivers an alert message to the control module 40 so that the first transistor 63, respectively the second transistor 64, of the auxiliary switch 62 is deactivated.

The first transistor 63, respectively the second transistor 64, is in the off state.

The sensor 67 comprises, for example, a temperature sensor measuring a temperature of the first transistor 63, respectively of the second transistor 64. In such a case, the functional parameter of the first transistor 63, respectively of the second transistor 64, is the temperature of the first transistor 63, respectively of the second transistor 64.

The determination means 68 compare the temperature value measured by the sensor 67 to a temperature threshold dependent on the technology of the first transistor 63, respectively of the second transistor 64, whether it is made of gallium nitride (GaN) or made of silicon carbide (SiC).

If the temperature measured by the sensor 67 is greater than the temperature threshold, the determination means 68 deliver the alert message.

Alternatively, the sensor 67 comprises a voltage sensor measuring a drain source voltage of the first transistor 63, respectively of the second transistor 64. In such a case, the functional parameter of the first transistor 63, respectively of the second transistor 64, is the drain source voltage of the first transistor 63, respectively of the second transistor 64.

The determination means 68 compare the value of the drain source voltage measured by the sensor 67 to a voltage threshold dependent on the technology of the first transistor 63, respectively of the second transistor 64, whether it is made of gallium nitride (GaN) or made of silicon carbide (SiC).

If the drain source voltage measured by the sensor 67 is greater than the voltage threshold, the determination means 68 deliver the alert message.

According to yet another alternative, the sensor 67 measures a drain source voltage, a current passing through the drain and a temperature of the first transistor 63, respectively of the second transistor 64.

The determination means 68 determine the value of the drain source resistance of the first transistor 63, respectively of the second transistor 64, and compare the determined value to a failure threshold.

If the value of the drain source resistance determined for the first transistor 63, respectively of the second transistor 64, is greater than the failure threshold, the determination means 68 deliver the alert message.

The monitoring module 66 allows to detect a failure and/or a drift of at least one of the auxiliary switches 62 so that, upon the detection of a failure and/or of a drift, all of the auxiliary switches are deactivated to prevent the propagation of a defect in the electrical power converter 2 capable of causing the failure of the electrical power converter 2, of the electric load 3 and/or of the supply source 4.

The control module 40 is further connected to a current sensor 69. The current sensor 69 measures a current circulating in the first phase 35, the second phase 36 and the third phase 37 of the electric load 3.

Alternatively, the current sensor 69 is disposed outside of the electric load 3.

As long as no failure or a drift of an auxiliary switch 62 has been detected, the control module 40 controls the first main switch 21 and the second main switch 22 of the corresponding switching arm, according to the exemplary embodiment the first main switching arm 18, the second main switching arm 19 and/or the third main switching arm 20, and the corresponding switching cell, according to the exemplary embodiment the first switching cell 44, the second switching cell 45 and/the third switching cell 46, so that the electrical power converter 2 delivers three levels of voltage on each phase of the electric load 3 to supply power to and control the electric load 3.

Thus:
a first voltage level equal to +Ve is delivered by the first main switch 21 of each switching arm, according to the exemplary embodiment the first main switching arm 18, the second main switching arm 19 and/or the third main switching arm 20,
a second voltage level equal to −Ve is delivered by the second main switch 22 of each switching arm, according to the exemplary embodiment the first main switching arm 18, the second main switching arm 19, and/or the third main switching arm 20, and
a null third voltage level is delivered by the switching cell, according to the exemplary embodiment the first switching cell 44, the second switching cell 45 and/or the third switching cell 46.

The first transistor 63 of the switching cell, according to the exemplary embodiment the first switching cell 44, the second switching cell 45, and/or the third switching cell 46, is turned off when the voltage between the first phase 35, the second phase 36, the third phase 37 of the electric load 3 and a ground is negative. Moreover, the second transistor 64 of the switching cell, according to the exemplary embodiment the first switching cell 44, the second switching cell 45 and/or the third switching cell 46, is turned off when the voltage between the first phase 35, the second phase 36, the third phase 37 of the electric load 3 and a ground is positive so as to ensure the reversibility of the current in the phase.

Upon the deactivation of the auxiliary switch 62, the control module 40 deactivates the auxiliary circuit 7 and controls the first main switch 21, and the second main switch 22 of the corresponding switching arm, according to the exemplary embodiment the first main switching arm 18, the second main switching arm 19 and/or the third main switching arm 20, so that the electrical power converter 2 delivers two voltage levels on each phase of the electric load 3 to supply power to and control the electric load 3.

Thus:
A first voltage level equal to +Ve is delivered by the first main switch 21 of each switching arm, according to the exemplary embodiment the first main switching arm 18, the second main switching arm 19, and/or the third main switching arm 20, and
a second voltage level equal to −Ve is delivered by the second main switch 22 of each switching arm, according to the exemplary embodiment the first main switching arm 18, the second main switching arm 19, and/or the third main switching arm 20.

The addition of the auxiliary circuit 7 to a power converter having two levels allows to create the power converter 2 having three levels. The electrical power converter 2 according to the invention implements auxiliary switches 62 made of silicon carbide (SiC) or made of gallium nitride (GaN) so that the electrical power converter 2 is less bulky and generates less thermal losses than a power converter having three levels known from the prior art.

Moreover, upon the detection of the failure or of the drift of an auxiliary switch 62 by the monitoring module 66, the auxiliary circuit 7 is deactivated and the electrical power converter 2 delivers two voltage levels so that the electric load 3 is supplied with power thus ensuring a continuity of service.

The control module 40 implements, for example, an algorithm of the pulse width modulation type, also known by the acronym PWM.

Of course, the electrical power converter 2 can comprise a number of phases different than three according to the number of phases of the electric load 3.

FIG. 5 schematically illustrates a second exemplary embodiment of the supply module 5 according to the invention.

According to the second exemplary embodiment of the supply module 5, the supply module 5 differs from the exemplary embodiment illustrated in FIG. 2 in that
the supply line 13 does not include an additional connection 17, and
the supply module 5 comprises an auxiliary switching arm 70, or first auxiliary switching arm 70, comprising a first end 71 connected to the first input terminal 8 of the supply module 5 and a second end 72 connected to the second input terminal 9 of the supply module 5.

The auxiliary switching arm 70 includes a first secondary switch 73 including a first end 75 and a second end 77 and a second secondary switch 74 including a first end 76 and a second end 78. Preferably, the first secondary switch 73 and the second secondary switch 74 are identical.

The first end 75 of the first secondary switch 73 is connected to the first end 71 of the auxiliary switching arm 70. The second end 77 of the first secondary switch 73 is connected to the first end 76 of the second secondary switch 74. Moreover, the second end 78 of the second secondary switch 74 is connected to the second end 72 of the auxiliary switching arm 70.

A third connection 79, or median connection 79, is established between the first secondary switch 73 and the second secondary switch 74 and is connected to the second output terminal 11 of the supply module 5.

Preferably, the first secondary switch 73 and the second secondary switch 74 are identical. Thus, only one exemplary embodiment of the first secondary switch 73 is described in detail.

The first secondary switch 73 comprises a transistor 80, in particular of the silicon (Si) type, for example field effect of the MOSFET or IGBT type. Advantageously, the transistor 80 comprises a diode 81, in particular an internal diode 81.

A drain D2 of the transistor 80 and a cathode of the diode 81 are connected to the first end 75 of the first secondary switch 73. Moreover, a source S2 of the transistor 80 and an anode of the diode 81 are connected to the second end 77 of the first secondary switch 73. Finally, a gate G2 of the transistor 80 is connected to the control module 40 of the electrical power converter 2.

Alternatively, the transistor 80 comprises a bipolar transistor. In this case, a collector of the transistor is connected to the first end 75 of the first secondary switch 73. Moreover, an emitter of the transistor is connected to the second end 77 of the first secondary switch 73. Finally, a base of the transistor is connected to the control module 40.

The transistor 80 has a proven technology, in particular for aeronautical uses.

The electrical power converter 2 including the supply module 5 according to this embodiment delivers two voltage levels:
a first voltage level equal to +Ve is delivered by the first main switch 21 of each switching arm, according to the exemplary embodiment the first main switching arm 18, the second main switching arm 19 and/or the third main switching arm 20, and
a second voltage level equal to −Ve is delivered by the second main switch 22 of each switching arm, according to the exemplary embodiment the first main switching arm 18, the second main switching arm 19 and/or the third main switching arm 20.

The auxiliary circuit 7 is deactivated.

Upon the detection of the failure or of the drift of the first main switch 21 and/or of the second main switch 22 of one of the main switching arms, according to the exemplary embodiment the first main switching arm 18, the second main switching arm 19, and/or the third main switching arm 20, the faulty or drifting first main switch 21 and/or second main switch 22 is deactivated by the control module 40.

As long as no failure or a drift of the auxiliary switch 62 has been detected, the control module 40 controls the switching cell 62 of the first control line 41, respectively of the second control line 42 and/or of the third control line 43, connected to the first main switching arm 18, respectively to the second main switching arm 19 and/or to the third main switching arm 20, comprising the faulty or drifting first main switch 21, respectively second main switch 22 and/or third main switch 23, and the first secondary switch 73 and/or the second secondary switch 74, so as to supply power to the phase connected to the faulty or drifting main switch of the electric load 3 by two voltage levels.

The first secondary switch 73, respectively the second secondary switch 74, controlled by the control module 40 is substituted for the faulty or drifting switch. The first secondary switch 73, respectively the second secondary switch 74, forms a substitution switch that is controlled by the control module 40 in the same way as the faulty or drifting main switch. The switching cell 62 is controlled by the control module 40 so as to let the voltage and the current delivered by the first secondary switch 73, respectively the second secondary switch 74, as a substitution switch, pass through.

In particular, upon the detection of a failure of the first main switch 21 of the first main switching arm 18 and/or of the second main switching arm 19 and/or of the third main switching arm 20, the control module 40 controls the first secondary switch 73 and the switching cell 62 of the first control line 41 and/or of the second control line 42 and/or of the third control line 43 respectively connected to the first main switching arm 18, to the second main switching arm 19 or to the third main switching arm 20 comprising the faulty or drifting first main switch 21.

Upon the detection of a failure of the second main switch 22 of the first main switching arm 18 and/or of the second main switching arm 19 and/or of the third main switching arm 20, the control module 40 controls the second secondary switch 74 and the switching cell 62 of the first control line 41 and/or of the second control line 42 and/or of the third control line 43 connected to the first main switching arm 18, to the second main switching arm 19 or to the third main switching arm 20 comprising the faulty or drifting second main switch 22.

The auxiliary circuit 7 and the auxiliary switching arm 70 allow to overcome a failure of the first main switch 21 and/or of the second main switch 22 of the first main switching arm 18 and/or of the second main switching arm 19 and/or of the third main switching arm 20 allowing to ensure the continuity of service of the electrical power converter 2.

If the first switching cell 44 and/or the second switching cell 45 and/or the third switching cell 46 of the auxiliary circuit 7 is/are faulty or drifting, the control module 40 deactivates the electrical power converter 2, the electric load 3 no longer being supplied with power.

Reference is now made to FIG. 6 which schematically shows a third embodiment of the electrical power converter 2 according to the invention.

According to the third embodiment, the electrical power converter 2 comprises an auxiliary circuit 7, preferably, identical to the auxiliary circuit 7 described in relation to the first embodiment of the drawing, connected to the supply module 5.

According to the third embodiment, the electrical power converter 2, the supply module 5 differs from the exemplary embodiment illustrated in FIG. 5 in that
the supply line 13 does not include an additional connection 17,
the supply module 5 comprises
   a first auxiliary switching arm 70 connected to the supply line 13 and to the second output terminal 11, similar to the auxiliary switching arm 70 as described in detail in FIG. 5, and
   in addition, at least one second auxiliary switching arm 82, in particular a second auxiliary switching arm 82 and a third auxiliary switching arm 83, in particular identical to the first auxiliary switching arm 70, and more specifically identical to the auxiliary switching arm 70 described in detail in FIG. 5.

The supply module 5 of the third embodiment, the electrical power converter 2 comprises as many auxiliary switching arms as control lines of the auxiliary circuit 7.

The supply module 5 of the third embodiment, the electrical power converter 2 comprises a first output terminal 10, a second output terminal 11 and a third output terminal 12.

The second auxiliary switching arm 82 comprises
a first end 84, connected to the first input terminal 8 of the supply module 5,
a second end 85, connected to the second input terminal 9 of the supply module 5, and
a fourth connection 86, or median connection 86, connected to the fourth output terminal 87 of the supply module 5.

The third auxiliary switching arm 83 comprises
a first end 88, connected to the first input terminal 8 of the supply module 5,
a second end 89, connected to the second input terminal 9 of the supply module 5, and
a fifth connection 90, or median connection 90, connected to the fifth output terminal 91 of the supply module 5.

The second output terminal 11 and the fourth output terminal 87 and the fifth output terminal 90 of the supply module 5 are connected to a different input of the auxiliary circuit 7.

When the electric load 3 comprises a number of phases different than three, the supply module 5 comprises as many auxiliary switching arms as control lines of the auxiliary circuit 7, each auxiliary switching arm being connected to a different control line of the auxiliary circuit 7.

For example, the second output terminal 11 is connected to a first input 50 of the auxiliary circuit 7, the fourth output terminal 87 is connected to a second input 51 of the auxiliary circuit 7 and the fifth output terminal 90 is connected to the third input 52 of the auxiliary circuit 7.

The first auxiliary switching arm 70 and the first control line 41 of the auxiliary circuit 7 allow to overcome a failure of the first main switch 21 and/or of the second main switch 22 of the first main switching arm 18.

The second auxiliary switching arm 82 and the second control line 42 of the auxiliary circuit 7 allow to overcome a failure of the first main switch 21 and/or of the second main switch 22 of the second main switching arm 19.

The third auxiliary switching arm 83 and the third control line 43 of the auxiliary circuit 7 allow to overcome a failure of the first main switch 21 and/or of the second main switch 22 of the third main switching arm 20.

The first auxiliary switching arm 70, the second auxiliary switching arm 82 and the third auxiliary switching arm 83 and the first control line 41, the second control line 42 and the third control line 43 function as described above to overcome the failure of the faulty or drifting first main switch 21 and/or second main switch 22.

In the embodiment of FIG. 6, the supply module 5 and the auxiliary circuit 7 allow to overcome the failure or the drift of the first main switch 21 and/or of the second main switch 22 per main switching arm as long as the auxiliary circuit 7 is not deactivated.

Contrary to the embodiment illustrated in FIG. 5 allowing to overcome a single failure or drift of the first main switch 21 and/or of the second main switch 22 of all of the first main switching arm 18, the second main switching arm 19 and the third main switching arm 20, the embodiment illustrated in FIG. 6 allows to overcome three failures or drifts, each failure or drift appearing on the first main switch 20 and/or the second main switch 21 of the different first main switching arm 18, the second main switching arm 19 and/or the third main switching arm 20, allowing to improve the continuity of service of the electrical power converter 2.

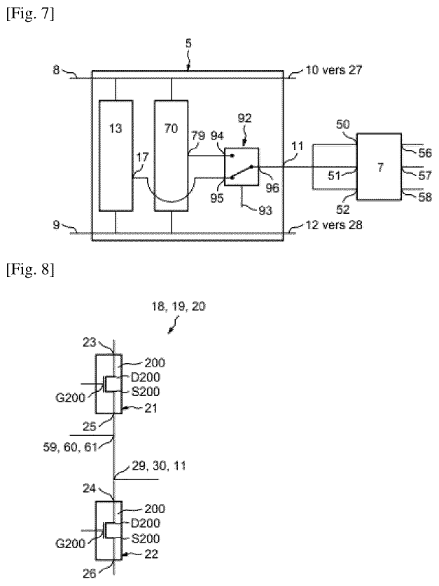

Reference is now made to FIG. 7 which schematically shows a third embodiment of the electrical power converter 2 according to the invention.

According to the third embodiment of the electrical power converter 2, the auxiliary circuit 7 is connected to a fourth exemplary embodiment of the supply module 5 comprising the supply line 13 and the auxiliary switching arm 70 as shown in FIG. 5.

Moreover, according to the third embodiment of the electrical power converter 2, the supply line 13 further comprises an additional connection 17.

In addition, the supply module 5 further comprises a selection switch 92. The selection switch 92 can include a control input 93, in particular connected to the control module 40, a first power input 94, a second power input 95 and a power output 96, in particular connected to the second output terminal 11 of the supply module 5.

According to the example presented, the first power input 94 is connected to the third connection 79 of the auxiliary switching arm 70 and the second power input 95 is connected to the additional connection 17 of the supply line 13.

As long as no failure or drift of one of the auxiliary switches 62 of the auxiliary circuit 7 has been detected, the control module 40 controls the selection switch 92 so that the second power input 95 is connected to the power output 96.

The electrical power converter 2 delivers three levels of voltage on the first phase 35, the second phase 36 and the third phase 37 of the electric load 3 as described in relation to FIG. 2.

If one of the auxiliary switches 62 of the auxiliary circuit 7 is faulty or drifting, the auxiliary circuit 7 is deactivated and the electrical power converter 2 delivers two levels of voltage on the first phase 35, the second phase 36 and the third phase 37 of the electric load 3 as described in relation to FIG. 2.

As long as no failure or drift of one of the auxiliary switches 62 of the auxiliary circuit 7 has been detected, and if the first main switch 21 and/or the second main switch 22 of the first main switching arm 18, respectively of the second main switching arm 19 and/or of the third main switching arm 20, is faulty, the control module 40 controls the selection switch 92 so that the first power input 94 is connected to the power output 96.

Then, the control module 40 controls the auxiliary circuit 7 and the auxiliary switching arm 70 so that the faulty or drifting main switch is substituted by the first secondary switch 73 and/or the second secondary switch 74 of the auxiliary switching arm 70 as described in relation to FIG. 5.

The third embodiment of the electrical power converter 2 allows to obtain a power converter 2 delivering three levels of voltage when no failure or drift of one of the auxiliary switches 62 and of the first main switch 21 and/or of the second main switch 22 has been detected, the electrical power converter 2 generating less losses, and being able to be less bulky, than a converter with three levels known from the prior art.

If one of the auxiliary switches 62 is faulty or drifting, the electrical power converter 2 delivers two levels of voltage allowing to ensure the continuity of supply of the electric load 3.

Finally, if no failure or drift of one of the auxiliary switches 62 is detected and the first main switch 21 and/or the second main switch 22 is faulty or drifting, the first secondary switch 73 and/or the second secondary switch 74 is substituted for the faulty or drifting first main switch 21 and/or second main switch 22 allowing to ensure the continuity of supply of the electric load 3 upon the failure or the drift of the first main switch 21 and/or of the second main switch 22.

The reliability of the electrical power converter 2 allowing the continuity of supply of the electric load 3 is improved.

According to another embodiment, the supply module 5 comprises three auxiliary switching arms as shown in relation to FIG. 6, in particular the first auxiliary switching arm 70, the second auxiliary switching arm 82 and/or the third auxiliary switching arm 83.

According to such an arrangement,
the third connection 79 of the first auxiliary switching arm 70, the fourth connection 86 of the second auxiliary switching arm 82 and the fifth connection 90 of the third auxiliary switching arm 83 are connected to a first power input of a different selection switch,
a second power input of each different selection switch being connected to the first end 15 or to the additional connection 17 of the supply line 13, and
the power output of each selection switch being connected to an input of the auxiliary circuit 7.

In this other embodiment, if no failure or drift of one of the auxiliary switches 62 is detected and the first main switch 21 and/or the second main switch 22 of the first main switching arm 18, respectively of the second main switching arm 19 and/or of the third main switching arm 20, are faulty or drifting, the control module 40 controls one or more of the selection switches connected to the main switching arms including the faulty or drifting first main switch 21 and/or second main switch 22 so that the power output of the selection switches is connected to the first power input of the selection switches.

Then, the control module 40 controls the auxiliary switching arm 70 so that the faulty or drifting first main switch 21 and/or second main switch 22 are substituted by the first secondary switch 73 and/or the second secondary switch 74.

Such an embodiment allows to improve even more the reliability of the electrical power converter 2 by overcoming the failure or the drift of the first main switch 21 and/or of the second main switch 22 per main switching arm as long as no auxiliary switch 62 is faulty.

FIG. 8 schematically illustrates another embodiment of the first main switching arm 18, of the second main switching arm 19 and/or of the third main switching arm 20.

Such an embodiment of the first main switching arm 18, of the second main switching arm 19 and/or of the third main switching arm 20 can be combined with all of the embodiments of the electrical power converter 2 previously described. This allows to obtain an electrical power converter 2 even more compact and/or generating even less thermal losses.

The first main switch 21, respectively the second main switch 22, comprises a transistor 200, in particular a transistor 200 made of gallium nitride, in particular a field effect transistor 200 made of gallium nitride.

The transistor 200 comprises a drain D200, a source S200 and a gate G200. However, the transistor 200 does not include an internal diode.

The drain D200 of the transistor 200 of the first main switch 21 is connected to the first end 23 of the first main switch 21, the source S200 of the transistor 200 is connected to the second end 25 of the first main switch 21 and the gate G200 is connected to the control module 40.

The drain D200 of the transistor 200 of the second main switch 22 is connected to the first end 24 of the second main switch 22, the source S200 of the transistor 200 is connected to the second end 26 of the second main switch 22 and the gate G200 is connected to the control module 40.

In the detailed presentation of the invention that is made above, the terms used must not be interpreted as limiting the invention to the embodiments disclosed in the description that has just been given, but must be interpreted to include therein all the equivalents, the providing of which is within the reach of a person skilled in the art by applying their general knowledge to the implementation of the teaching that has just been disclosed to them.

Of course, the invention is not limited to the embodiments described above and provided only as examples. It covers various modifications, alternative forms and other variants that a person skilled in the art could envisage in the context of the present invention and in particular any combinations of the various operating modes described above, which can be taken separately or in association.

1. Electrical power converter for supplying power to an electric load, in particular of an aircraft, including:
a supply module, intended to be connected to a source of power, in particular a source of continuous power;
at least one main switching arm including a first main switch and a second main switch, in particular an identical first main switch and second main switch, respectively comprising a first end and a second end, the first end of the first main switch and the second end of the second main switch being connected to the supply module and the second end of the first main switch being connected to the first end of the second main switch;
at least one intermediate connection, arranged between the first main switch and the second main switch and intended to be connected to a phase of the electric load; and
an auxiliary circuit comprising as many control lines as main switching arms, at least one control line including at least one switching cell, including:
a first end, connected to the supply module; and
a second end, connected to the intermediate connection,
wherein the switching cell includes at least one auxiliary switch, in particular an auxiliary switch made of silicon carbide or made of gallium nitride.

2. Electrical power converter according to claim 1, wherein the electrical power converter includes a monitoring module configured to detect a failure or a drift of the auxiliary switch on the basis of functional parameters of the auxiliary switch and to deactivate the auxiliary switch upon the detection of a failure or of a drift of the auxiliary switch.

3. Electrical power converter according to claim 1, wherein the supply module includes a supply line comprising a first end and a second end intended to be connected to the source of power and wherein the supply line includes two impedances, in particular two identical impedances, in particular capable of being connected in series.

4. Electrical power converter according to claim 3, wherein the supply module includes an additional connection arranged between the two impedances and intended to be connected to the first end of the switching cell.

5. Electrical power converter according to claim 1, wherein the electrical power converter includes at least one auxiliary switching arm including a first secondary switch and a second secondary switch, in particular an identical first secondary switch and second secondary switch, respectively comprising a first end and a second end, the second end of the first secondary switch being connected to the first end of the second secondary switch.

6. Electrical power converter according to claim 5, wherein a median connection is disposed between the first secondary switch and the second secondary switch and is connected to the first end of the switching cell of the control line.

7. Electrical power converter according to claim 5, wherein the first end of the first main switch and/or of the first secondary switch, and the second end of the second main switch and/or of the second secondary switch are connected respectively to a different end of the supply line.

8. Electrical power converter according to claim 1, wherein the supply module further includes a selection switch including a control input, a first power input, a second power input and a power output,
and configured to connect the power output to one of the power inputs according to a signal received on the control input.

9. Electrical power converter according to claim 8, wherein:
the first power input is connected to the median connection;
the second power input is connected to the additional connection; and
the power output is connected to the first end of the switching cell of the control line.

10. Electrical power converter according to claim 3, wherein the first main switch, respectively the second main switch, is made of silicon carbide or of gallium nitride.

11. Electrical power converter according to claim 3, wherein the first secondary switch, respectively the second secondary switch, is made of silicon.

12. Electrical power converter according to claim 1, wherein the first main switch, respectively the second main switch, includes a transistor, in particular a dual gate transistor, in particular a dual gate transistor made of gallium nitride.

13. Electrical power converter according to claim 1,
wherein the auxiliary switch includes at least a first transistor and a second transistor, in particular a first transistor and a second transistor made of gallium nitride, connected in series so that:
a source of the first transistor is connected to a drain of the second transistor; and
a drain of the first transistor and a source of the second transistor are connected to a different end of the switching cell.

14. Aircraft including an electrical power converter according to claim 1.

15. Method for supplying electric power to an electric load, in particular of an aircraft, connected to an electrical power converter according to claim 1:
comprising the control of the first main switch and of the second main switch so as to supply power a phase of the electric load,
wherein the method for supplying electric power to an electric load further comprises at least:
a step of detecting a failure or a drift of the auxiliary switch on the basis of functional parameters of the auxiliary switch; and
a step of deactivating the auxiliary switch upon the detection of a failure or of a drift of the auxiliary switch.

16. Method for supplying electric power to an electric load according to claim 15, further comprising:
a step of controlling the switching cell so as to supply power to the phase by three voltage levels as long as no failure or a drift of the auxiliary switch has been detected; and
a step of deactivating the auxiliary switch, the control of the first main switch and of the second main switch so as to supply power to the phase by two voltage levels.

17. Method for supplying electric power to an electric load according to claim 16, further comprising:
upon the detection of the failure or of the drift of the first main switch and of the second main switch, the deactivation of the faulty or drifting switch; and
as long as no failure or a drift of the auxiliary switch has been detected, the control of the switching cell and of the first secondary switch and/or of the second secondary switch so as to supply power to the phase of the load by two voltage levels, the controlled secondary switch being substituted for the faulty switch.
